(19) United States
(12) Patent Application Publication
(10) Pub. No.: US 2005/0180396 A1
(43) Pub. Date: Aug. 18, 2005

(54) Managing routing path of voice over internet protocol (VoIP) system

(76) Inventor: Pyung-Bin Lim, Suwon-si (KR)

Correspondence Address: Robert E. Bushnell;Suite 300, 1522 K Street, N.W., Washington, DC, 20005, US

(21) Appl. No.: 11/013,690

(22) Filed: Dec. 17, 2004

(30) Foreign Application Priority Data
Feb. 13, 2004 (KR) 2004-9778

(51) Int. Cl. H04L 12/66

(52) U.S. Cl. 370/352

(57) ABSTRACT

A VoIP routing method and system and a program storage device, readable by a machine, tangibly embodying a program of instructions executable by the machine to perform the VoIP routing method includes: receiving information as to whether a failure has occurred in VoIP gateways of VoIP system; and establishing a routing path by selecting a VoIP gateway where a failure has not occurred to bypass a VoIP gateway where a failure has occurred in accordance with the received information.

### CLAIM OF PRIORITY

This application makes reference to, incorporates the same herein, and claims all benefits accruing under 35 U.S.C. § 119 from an application for METHOD FOR MANAGING ROUTING PATH OF VOICE OVER INTERNETPROTOCOL SYSTEM AND THE SAME earlier filed in the Korean Intellectual Property Office on 13 Feb. 2004 and there duly assigned Serial No. 2004-9778.

### BACKGROUND OF THE INVENTION

1. Field of the Invention

The present invention relates to managing a routing path in a Voice over Internet Protocol (VOIP) system and, more particularly, to a VoIP routing method and system and a program storage device, readable by a machine, tangibly embodying a program of instructions executable by the machine to perform the VoIP routing method which routes a VoIP call from a first VoIP gateway to a second VoIP gateway upon the occurrence of a telephone network failure in the first VoIP gateway.

1. Description of the Related Art

VoIP is an Internet Protocol (IP) telephone technique for delivering voice information using an IP network. Generally, VoIP is not a traditional protocol based on a link as in a Public Switched Telephone Network (PSTN) which is a representative telephone network, but rather is a protocol that transmits voice information in a digital form within discrete packets.

A VoIP system consists of a Private Branch Exchange (PBX) or a Key Phone (K/P) to provide extension subscribers with a telephone switching service through a telephone network, VoIP gateways connected to the PBX (or K/P) over the telephone network to connect the PBX (or K/P) to the IP network, and a gatekeeper for managing the VoIP gateways.

When each of the gateways receives respective VoIP call connecting attempt signals from the extension subscribers of the PBX (or K/P), it converts a relevant VoIP call connecting attempt signal to information in packet form and attempts to connect the VoIP call through the IP network, and provides the VoIP service when it determines that the VoIP call can be connected through the IP network.

The gatekeeper is an H.323 entity defined in an H.323 protocol, which is a multimedia communication standard of the International Telecommunications Union-Telecommunications (ITU-T), and is equipment that controls, manages, and integrates end points, i.e., gateways, terminals, and Micro Controller Units (MCUs), by grouping them into one control area that is defined as a zone.

To perform the VoIP service by setting up a call in the IP network, the gateway must first request a gatekeeper, in which the gateway has been registered, to authenticate the gateway and accept it for the call setup.

The following is a description of a procedure for requesting and accepting authentication for the call setup between the gateway and the gatekeeper.

A first VoIP gateway first requests authentication by transmitting an Admission Request (ARQ), which is an authentication request message, to the gatekeeper to perform a call attempt to a second VoIP gateway.

In response to the ARQ transmitted from the first VoIP gateway, the gatekeeper performs authentication on the relevant gateway to determine whether the gateway is a valid user, sends an authentication confirmation message, referred to as an Admission Confirmation (ACF), to the relevant gateway if the VoIP gateway is the valid user, and then continues to provide a call service.

If the gateway that has requested the authentication is not the valid user, the gatekeeper sends a rejection message, referred to as a Registration Reject (RRJ), indicating the authentication is not accepted and then stops.

With such an operation of the gatekeeper, the first gateway receives the ACF message from the gatekeeper and requests the setup to the gatekeeper in response to the message. The gatekeeper then requests the call setup to the second relevant gateway. The second gateway that has received the call setup sends a call setup message to the PSTN and receives an alerting message forwarded from the PSTN. In addition, the second gateway transmits a call processing message, indicating that the call processing is being effected in response to the call setup request, to the first gateway via the gatekeeper and subsequently transmits the alerting message to notify the first gateway that the second gateway is being called. The connection is established when the second gateway responds to the call.

As such, to receive the VoIP service, the gateway is adapted to send the ARQ message to the gatekeeper in which the gateway has been registered, receive the ACF message from the gatekeeper, and request the call setup to receive the call service in response to receiving the ACF message.

H.323 ID or E.164 is used to request the ARQ, which can be set and changed by the user at the gateway.

The second gateway that has received the call setup sends the call setup message to the PSTN, in which the second gateway notifies the gatekeeper that the call cannot be set up by sending an error or release message rather than alert and connect messages to the gatekeeper if the PSTN interface in the second gateway has a failure or available ports are all busy.

As mentioned above, the VoIP gateway is interfaced with the PBX (or K/P) via the PSTN at one side and is interfaced with the VoIP at the other side. In this VoIP gateway, when call is incoming over the VoIP with a failure in the PSTN, it obstructs call processing such that the call is not established for the user.

If the gatekeeper, which does not recognize that the failure has occurred in the PSTN interface for the VoIP gateway that connects the PBX (or K/P) to the VoIP gateway, instructs the VoIP gateway to set up the call in spite of the occurrence of the failure, the VoIP call setup will be failed. Thus, there is a problem in that a stable VoIP service cannot be provided.

The following patents each discloses features in common with the present invention but do not teach or suggest the inventive features specifically recited in the present claims: U.S. Patent Application No. 2002/0141562 to Matsuura, entitled GATEWAY SYSTEM AND FAULT MANAGEMENT METHOD, issued on Oct. 3, 2002; U.S. Patent Application No. 2002/0154626 to Ryu, entitled TELEPHONY SERVICE SYSTEM USING A VOICE OVER INTERNET PROTOCOL BASED ON A NETWORK, issued on Oct. 24, 2002; U.S. Patent Application No. 2002/0186685 to O'Brien Jr. et al., entitled VOICE OVER INTERNET PROTOCOL REAL TIME PROTOCOL ROUTING, issued on Dec. 12, 2002; U.S. Patent Application No. 2002/0176374 to Lee et al., entitled VOICE OVER INTERNET PROTOCOL GATEWAY AND A METHOD FOR CONTROLLING THE SAME, issued on Nov. 28, 2002; U.S. Patent Application No. 2003/0131132 to Cheng et al., entitled METHOD AND SYSTEM FOR A ROUTING SERVER FOR SELECTING A PSTN GATEWAY, issued on Jul. 10, 2003; U.S. Patent Application No. 2004/0120312 to Yeom, entitled METHOD FOR CALL PROCESSING AND LINK TEST IN A VOIP GATEWAY AND SYSTEM THEREOF, issued on Jun. 24, 2004; and U.S. Patent Application No. 2002/0114278 to Coussement, entitled CAPABILITY-BASED ROUTING, issued on Aug. 22, 2002.

### SUMMARY OF THE INVENTION

The present invention is conceived to solve the aforementioned problem. It is an object of the present invention to provide a method and system to manage a routing path in a VoIP system, in which a stable VoIP service is supported at all times for service subscribers for any situation.

According to an aspect of the present invention for achieving the object, a method is provided comprising: receiving information as to whether a failure has occurred in VoIP gateways of VoIP system; and establishing a routing path by selecting a VoIP gateway where a failure has not occurred to bypass a VoIP gateway where a failure has occurred in accordance with the received information.

A failure of a VoIP gateway comprises at least one of a network failure and an exhaustion of available ports.

Receiving the information comprises receiving information as to whether a failure has occurred in respective VoIP gateways via one of a wired network, a wireless network, and a recording medium.

Receiving the information comprises receiving information as to whether a failure has occurred in relevant VoIP gateways from the respective VoIP gateways.

The method further comprises sending the received information on a message transmitted between a VoIP gateway and a management server.

The message comprises at least one of a field indicating a presence or absence of available ports, a field for a protocol ID, and an ID field for a VoIP gateway.

Receiving the information comprises receiving information as to whether a system failure has occurred in respective VoIP gateways via network equipment other than the VoIP gateways.

The method further comprises generating a database to establish the routing path in accordance with the received information.

The method further comprises updating the database based on new information as to whether a failure has occurred in respective VoIP gateways in accordance with receipt of the new information.

The database comprises a table.

The database comprises at least one of an IP address and a MAC address of the VoIP gateway.

The database comprises information on a VoIP gateway where a failure has occurred and a VoIP gateway to bypass the VoIP gateway where a failure has occurred.

According to an aspect of the present invention for achieving the object, a method is provided comprising: determining whether a failure has occurred in each of more than one VoIP gateway and transmitting information as to whether a failure has occurred; generating a database including information as to whether a failure has occurred in accordance with the information transmitted from the VoIP gateway, the database being generated by a management server; and establishing a routing path by selecting a VoIP gateway where a failure has not occurred to bypass a VoIP gateway where a failure has occurred in accordance with the database, the routing path being established by the management server.

The method further comprises sending the information on a message between the VoIP gateway and the management server.

The message comprises at least one of a field indicating a presence or absence of available ports, a field for a protocol ID, and a field for a VoIP gateway.

The database comprises information on a VoIP gateway where a failure has occurred and a VoIP gateway to bypass the VoIP gateway where a failure has occurred.

According to another aspect of the present invention for achieving the object, a VoIP system is provided comprising: VoIP gateways adapted to determine if a failure has occurred in VoIP gateways and to transmit information as to whether a failure has occurred; and a management server adapted to receive information as to whether a failure has occurred and to generate a database including information as to whether a failure has occurred in the VoIP gateways in accordance with the received information transmitted from the VoIP gateways, and to establish a routing path by selecting a VoIP gateway where a failure has not occurred to bypass a VoIP gateway where a failure has occurred in accordance with the database.

A failure of a VoIP gateway comprises at least one of a network failure and an exhaustion of available ports.

The information is transmitted on a message between a VoIP gateway and the management server.

The message comprises at least one of a field indicating a presence or absence of available ports, a field for a protocol ID, and a field for a VoIP gateway.

The database comprises information on a VoIP gateway where a failure has occurred and a VoIP gateway to bypass the VoIP gateway where a failure has occurred.

The management server is adapted to update the database for establishing the routing path based on new information as to whether a system failure has occurred in the respective VoIP gateways in response to receipt of the new information.

According to still another aspect of the present invention for achieving the object, a program storage device, readable by a machine, tangibly embodying a program of instructions executable by the machine is provided to perform a method comprising: receiving information as to whether a failure has occurred in VoIP gateways of VoIP system; and establishing a routing path by selecting a VoIP gateway where a failure has not occurred to bypass a VoIP gateway where a failure has occurred in accordance with the received information.

A failure of a VoIP gateway comprises at least one of a network failure and an exhaustion of available ports.

Receiving the information comprises receiving information as to whether a failure has occurred in respective VoIP gateways via one of a wired network, a wireless network, and a recording medium.

Receiving the information comprises receiving information as to whether a failure has occurred in relevant VoIP gateways from the respective VoIP gateways.

The method further comprises sending the received information on a message transmitted between a VoIP gateway and a management server.

The message comprises at least one of a field indicating a presence or absence of available ports, a field for a protocol ID, and an ID field for a VoIP gateway.

Receiving the information comprises receiving information as to whether a system failure has occurred in respective VoIP gateways via network equipment other than the VoIP gateways.

The method further comprises generating a database to establish the routing path in accordance with the received information.

The method further comprises updating the database based on new information as to whether a failure has occurred in respective VoIP gateways in accordance with receipt of the new information.

The database comprises a table.

The database comprises at least one of an IP address and a MAC address of the VoIP gateway.

The database comprises information on a VoIP gateway where a failure has occurred and a VoIP gateway to bypass the VoIP gateway where a failure has occurred.

According to yet another aspect of the present invention for achieving the object, a program storage device, readable by a machine, tangibly embodying a program of instructions executable by the machine is provided to perform a method comprising: determining whether a failure has occurred in each of more than one VoIP gateway and transmitting information as to whether a failure has occurred; generating a database including information as to whether a failure has occurred in accordance with the information transmitted from the VoIP gateway, the database being generated by a management server; and establishing a routing path by selecting a VoIP gateway where a failure has not occurred to bypass a VoIP gateway where a failure has occurred in accordance with the database, the routing path being established by the management server.

The method further comprises sending the information on a message between the VoIP gateway and the management server.

The message comprises at least one of a field indicating a presence or absence of available ports, a field for a protocol ID, and a field for a VoIP gateway.

The database comprises information on a VoIP gateway where a failure has occurred and a VoIP gateway to bypass the VoIP gateway where a failure has occurred.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a view of a procedure for requesting and accepting authentication for a call setup between a gateway and a gatekeeper;

FIG. 2 is an actual configuration diagram of a VoIP system consisting of gateways and a gatekeeper to explain the features of the present invention;

FIG. 3 is a view of a failure occurring in a PSTN interface between a VoIP gateway and a K/P (or PBX);

FIG. 4 is a view of a failure that has been restored in a PSTN interface between a VoIP gateway and a K/P (or PBX); and

FIG. 5 is a flowchart of call routing management between a gateway and a gatekeeper in accordance with an embodiment of the present invention.

### DETAILED DESCRIPTION OF THE INVENTION

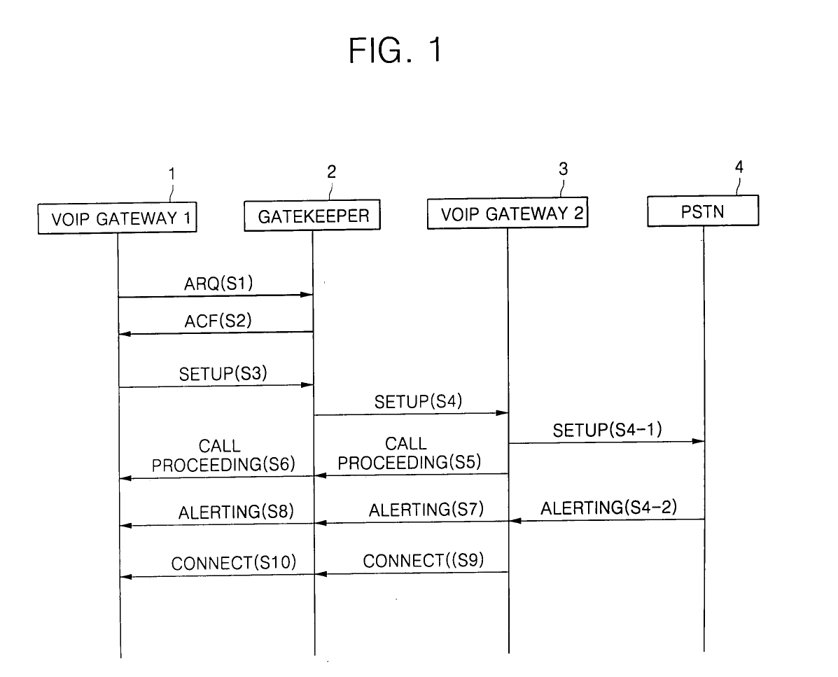

FIG. 1 is a view of a procedure for requesting and accepting authentication for a call setup between a gateway and a gatekeeper.

Referring to FIG. 1, a first VoIP gateway 1 first requests authentication by transmitting an admission request (ARQ), which is an authentication request message, to the gatekeeper 2 to perform a call attempt to a second VoIP gateway 3 (S1).

In response to the ARQ transmitted from the first VoIP gateway 1, the gatekeeper 2 performs authentication on the relevant gateway to determine whether the gateway is a valid user, sends an authentication confirmation message, referred to as an Admission Confirmation (ACF) to the relevant gateway if the VoIP gateway is the valid user, and then continues to provide a call service.

If the gateway that has requested the authentication is not the valid user, the gatekeeper sends a rejection message, referred to as Registration Reject (RRJ), indicating that the authentication has been rejected and then stops.

With such an operation of the gatekeeper 2, the first gateway 1 receives the ACF message from the gatekeeper 2 (S2) and requests the setup to the gatekeeper 2 (S3) in response to the message. The gatekeeper 2 then requests the call setup to the second relevant gateway 3 (S4). The second gateway 3 that has received the call setup sends a call setup message to the PSTN 4 (S4-1) and receives an alerting message forwarded from the PSTN 4 (S4-2). In addition, the second gateway transmits a call processing message, indicating that the call processing is being effected in response to the call setup request, to the first gateway 1 via the gatekeeper 2 (S5, S6) and subsequently transmits the alerting message to notify the first gateway that the second gateway 3 is being called (S7, S8). The connection is established when the second gateway 3 responds to the call (S9, S10).

As such, to receive the VoIP service, the gateway is adapted to send the ARQ message to the gatekeeper in which the gateway has been registered, receive the ACF message from the gatekeeper, and request the call setup to receive the call service in response to receiving the ACF message.

H.323 ID or E.164 is used to request the ARQ, which can be set and changed by the user at the gateway.

As shown in FIG. 1, the second gateway 3 that has received the call setup sends the call setup message to the PSTN 4, in which the second gateway notifies the gatekeeper 2 that the call cannot be set up by sending an error or release message rather than alert and connect messages to the gatekeeper if the PSTN interface 4 in the second gateway 3 has a failure or available ports are all busy.

As mentioned above, the VoIP gateway is interfaced with the PBX (or K/P) via the PSTN at one side and is interfaced with the VoIP at the other side. In this VoIP gateway, when a call is incoming over the VoIP with a failure in the PSTN, it obstructs call processing such that the call is not established for the user.

If the gatekeeper, which does not recognize that the failure has occurred in the PSTN interface for the VoIP gateway that connects the PBX (or K/P) to the VoIP gateway, instructs the VoIP gateway to set up the call in spite of the occurrence of the failure, the VoIP call setup will be failed. Thus, there is a problem in that a stable VoIP service cannot be provided.

Hereinafter, the present invention will be described in detail with reference to the accompanying drawings. An H.323 or SIP protocol can be used for a signal protocol in performing a method for managing a routing path of a VoIP system in accordance with the present invention. A gatekeeper can be used as a management server managing a VoIP gateway if the H.323 protocol is used as the signal protocol to implement the VoIP system while a SIP server can be used as the management server managing the VoIP gateway if the SIP protocol is used. Thus, although the type of management server can vary depending on a signaling protocol in use and there can be some differences in the type of a message, the method for managing the routing path in accordance with the present invention can be applied to any arrangement. In the following embodiments, a system in which the gatekeeper is used as a management server using an H.323 protocol will be described by way of example.

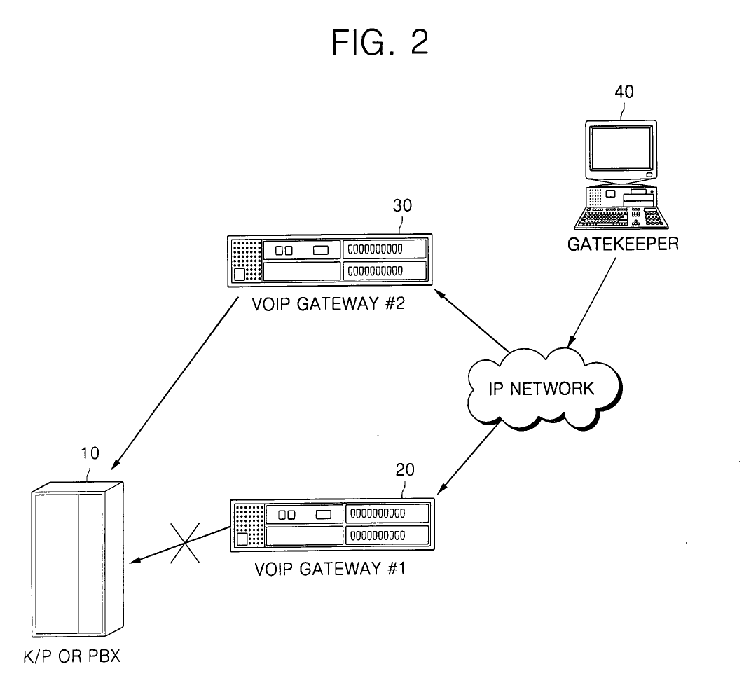

FIG. 2 is an actual configuration diagram of a VoIP system consisting of gateways and a gatekeeper to explain the features of the present invention.

Referring to FIG. 2, a PBX (or K/P) 10 is connected to an IP network via each of first and second VoIP gateways 20 and 30, and receives a VoIP service under the management of a gatekeeper 40.

The gatekeeper 40 can diagnose various problems that have occurred in the respective VoIP gateways 20 and 30 in advance and take actions beforehand by routing the call to another gateway.

To implement this, if PSTN circuit ports are all busy or there are no available ports due to a PSTN circuit failure, each of the VoIP gateways 20 and 30 sends a message indicating that fact to the gatekeeper 40. The gatekeeper receiving the relevant message can route the call to another VoIP gateway rather than route the call to the failed VoIP gateway.

When receiving information indicating operating states of the respective VoIP gateways 20 and 30 from the VoIP gateways 20 and 30, the gatekeeper 40 stores information in a database as to whether or not it has performed routing to the relevant gateway. IP addresses, Media Access Control (MAC) addresses, and the like of the VoIP gateways can be stored in the database. It is preferable that the database is in a table form.

The VoIP gateways send a message to the gatekeeper indicating that the service is possible when the failure of the PSTN interface has been restored or any available ports exist, which makes it possible to again route the VoIP call.

As stated above, the gatekeeper can recognize in advance that the PSTN interface of the first VoIP gateway 20 has had a failure and bypasses the first VoIP gateway 20 so that the VoIP call is routed to the second gateway 30.

That is, a stable VoIP call service can be advantageously provided at all times to the subscriber. In terms of the VoIP network management, the gatekeeper recognizes the occurrence of failure in the relevant VoIP gateway in advance to route a call to another gateway when the failure occurs.

In addition, when the PSTN interface of the first VoIP gateway 20 has been restored from the failure, it notifies the gatekeeper of its normal state to provide a normal service for the next calls.

One exemplary message transmitted from the VoIP gateway to the gatekeeper can contain a ReqSeqNum field, a ProtocolID field, a NonStandardData field, a GatewayID for a gateway, a MyResources field, a Reserved field, and the like.

The ReqSeqNum field is used to indicate an order in which the VoIP gateway sends a message to the gatekeeper and, in response to the message, the gatekeeper sends an acknowledgment message to the relevant VoIP gateway.

The ProtocolID field indicates a protocol ID used to transmit and receive a message between the VoIP gateway and the gatekeeper, the NonstandardData field indicates a non-standard data format, and the GatewayID indicates the ID of a gateway that sends a relevant message to the gatekeeper. A MAC address can be used for the ID of the gateway.

The MyResources field is a field indicating whether or not the VoIP gateway operates normally and has normally available ports. This field is set to a value (TRUE) indicating a normal state when the system is normal and to a value (FALSE) indicating failure when the system is abnormal or does not have available ports.

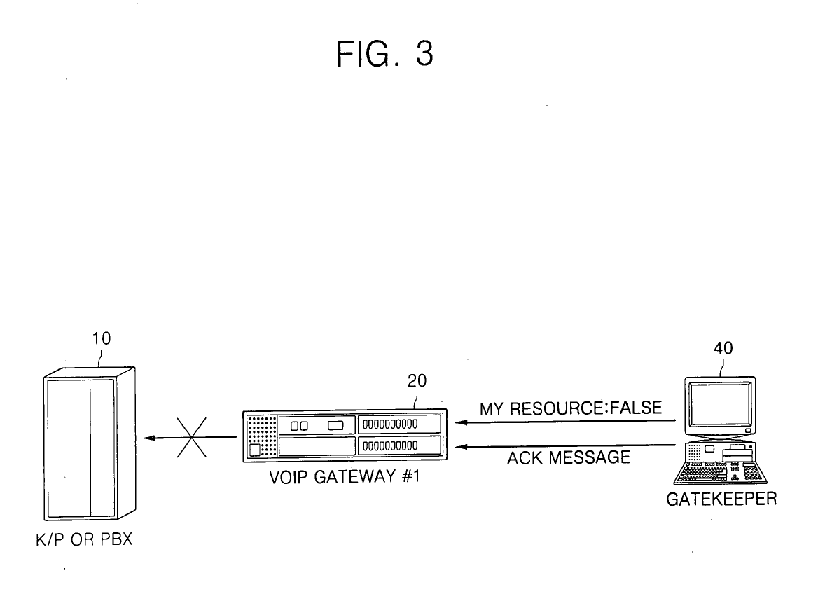

FIG. 3 is a view of a failure occurring in a PSTN interface between a VoIP gateway and a K/P (or PBX). Referring to FIG. 3, if a failure in the PSTN interface between the VoIP gateway 20 and the K/P (PBX) 10 occurs, the gatekeeper 40 is notified that there are no available ports due to the occurrence of the failure, and then the gatekeeper 40, which has received the message bypasses the first VoIP gateway 20 to continue to route the VoIP call service to another gateway other than the gateway #1(20) from the time of the next VoIP call.

As such, when a failure occurs at the resource provided from its own system, for example, when the PSTN line has a failure or all ports are busy, each of the VoIP gateways 20 and 30 operate as follows.

When the PSTN line between the VoIP gateway 20 and the gatekeeper 40 has a failure, the VoIP gateway 20 determines that the resource exceeds the reference value, and sets the MyResource Field of the relevant message to be 0 (False) to send it to the gatekeeper 40, which in turn receives the message to block the relevant VoIP gateway 20 and route the next VoIP call to another VoIP gateway.

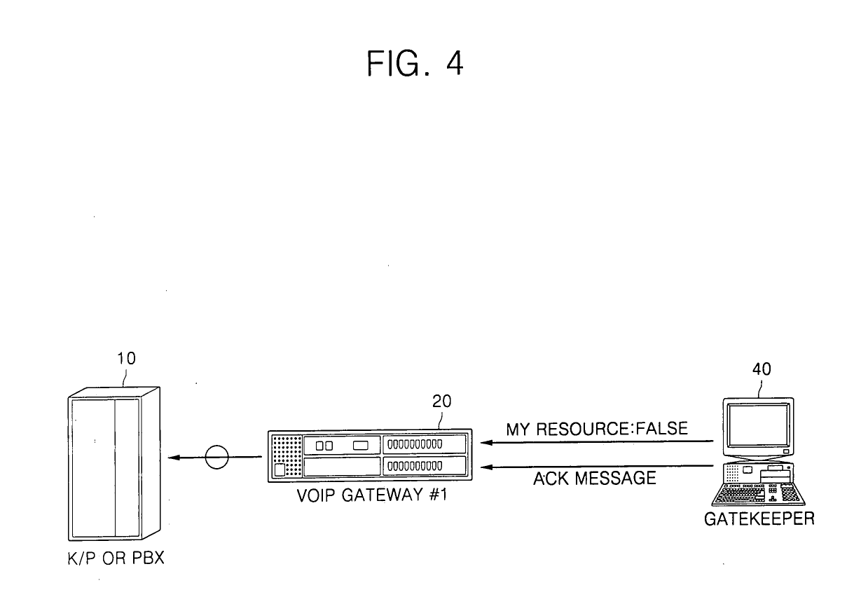

FIG. 4 is a view of a failure that has been restored in a PSTN interface between a VoIP gateway and a K/P (or PBX). Referring to FIG. 4, when the VoIP gateway 20 is restored from the failure, it transmits a message to the gatekeeper 20 indicating that the VoIP gateway can provide call service in a normal state. The gatekeeper 40 can then continue to route the VoIP call in a normal state.

When the resource is restored, namely, when the PSTN line is restored or available ports exist, the VoIP gateway operates as follows.

When the PSTN line between the VoIP gateway 20 and the gatekeeper 40 is restored from the failure, the gateway notifies the gatekeeper 40 that its own resource can be available.

In other words, the gateway sets the MyResource Field of the relevant message to be 1 (True) and sends it to the gatekeeper.

The gatekeeper 40, which has received it, unblocks the relevant VoIP gateway 20 and continues to route the next VoIP call in a normal state.

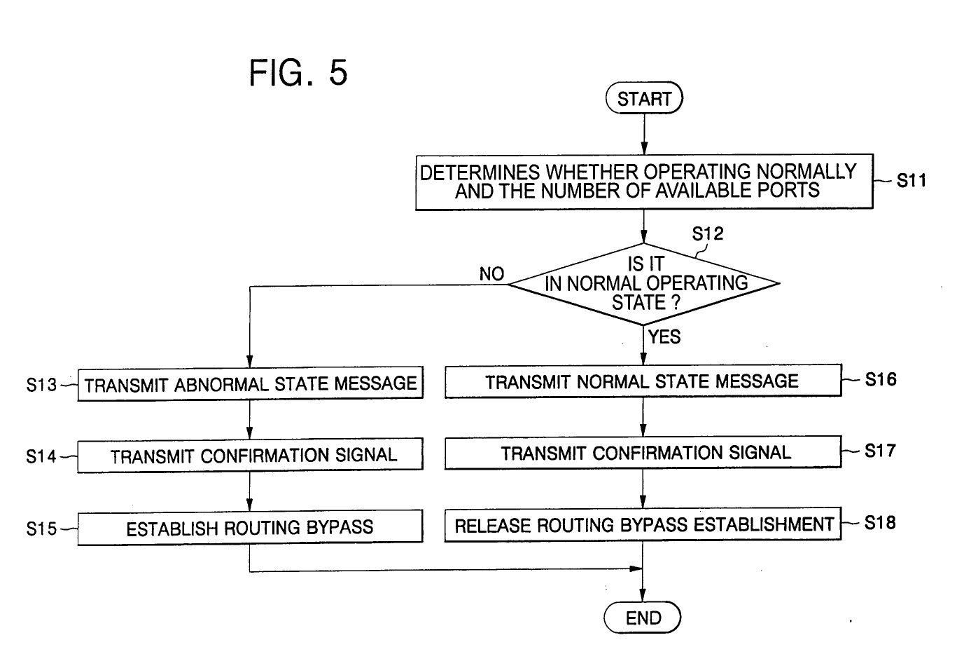

FIG. 5 is a flowchart of call routing management between a gateway and a gatekeeper in accordance with an embodiment of the present invention.

Referring to FIG. 5, the first VoIP gateway 20 determines if its own PSTN interface is connected normally to the PBX 10 and operates normally, and the number of available PSTN ports in the gateway system (S11). The VoIP gateway determines if the system operates normally based on the determined result (S12). The normal operation of the system means that the PSTN interface is normally connected to the PBX (10) and operates normally and the number of the available PSTN ports is not less than a suitable value. Thus, in FIG. 2, the first VoIP gateway 20 sets a value (i.e., false) to the MyResource field indicating an abnormal operating state due to a failed PSTN and sends it to the gatekeeper 40 (S13). The gatekeeper, which has received the message including the MyResource field indicating the abnormal operating state from the first VoIP gateway 20, transmits an acknowledgment signal to the first VoIP gateway 20 to notify it that the gatekeeper has securely received the message transmitted from the first VoIP gateway 20 (S14). In addition, the gatekeeper performs a routing bypass setup in the database to block the routing to the first VoIP gateway 20 (S15).

When the system is restored from the abnormal state to allow the PSTN to operate normally and to connect the first VoIP gateway 20 normally to the PBX 10 and the number of available PSTN ports is not less than a suitable value, the VoIP gateway #1(20) then sets the MyResource field to be a True logic indicating the normal operating state and sends it to the gatekeeper 40 (S16). The gatekeeper, which has received the message including the MyResource field indicating the normal operating state from the VoIP gateway #1(20), transmits the acknowledgment signal to the VoIP gateway #1(20) to notify it that the gatekeeper has securely received the message transmitted from the VoIP gateway (S17). In addition, the gateway unblocks the routing bypass state, which has been set in the database so as to block the routing and to bypass the VoIP gateway #1(20), and updates the database to allow the routing to be continued in the normal state (S18).

The gatekeeper can recognize whether the VoIP gateways operate normally from the message received from each of the VoIP gateways or through network equipment other than the VoIP gateways.

For example, a separate network management system, although not shown, can recognize the operating state of each of the VoIP gateways to transmit the operating state of each of the VoIP gateways to the gatekeeper.

In addition, if the gatekeeper receives a message from the network management system indicating whether or not each of the VoIP gateways is operating normally, it can transmit the relevant message through a wired/wireless network between the network management system and the gatekeeper, but it can receive the information indicating the operating state of each of the VoIP gateways through a recording medium using an operator's manual task. Alternatively, an operator can enter information indicating the operating state of the VoIP gateways to the gatekeeper one by one.

In accordance with the present invention, subscribers can be provided with VoIP call services in any situation.

In other words, although, in other arrangements, a subscriber at a caller side receives a busy or release message when a line between a VoIP gateway and a PSTN has a failure, in accordance with the present invention, the gatekeeper can sense the failure in advance based on the message presented by the VoIP gateway even when the failure has occurred in the PSTN interface, and the next VoIP call is bypassed to another VoIP gateway, thus providing a stable VoIP call service at all times.

In terms of the management server, e.g., a gatekeeper or an SIP server, system load can be reduced, as compared to the case that the management server receives an error message after a call is routed to the VoIP gateway where the failure has occurred, leading to more efficient and easier subscriber management.

While the present invention has been described with reference to particular embodiments, it is understood that the disclosure has been made for purpose of illustrating the invention by way of example and is not to be construed as limiting the scope of the present invention.

1. A method comprising:
receiving information as to whether a failure has occurred in VoIP gateways of VoIP system; and
establishing a routing path by selecting a VoIP gateway where a failure has not occurred to bypass a VoIP gateway where a failure has occurred in accordance with the received information.

2. The method as claimed in claim 1, wherein a failure of a VoIP gateway comprises at least one of a network failure and an exhaustion of available ports.

3. The method as claimed in claim 1, wherein receiving the information comprises receiving information as to whether a failure has occurred in respective VoIP gateways via one of a wired network, a wireless network, and a recording medium.

4. The method as claimed in claim 3, wherein receiving the information comprises receiving information as to whether a failure has occurred in relevant VoIP gateways from the respective VoIP gateways.

5. The method as claimed in claim 4, further comprising sending the received information on a message transmitted between a VoIP gateway and a management server.

6. The method as claimed in claim 5, wherein the message comprises at least one of a field indicating a presence or absence of available ports, a field for a protocol ID, and an ID field for a VoIP gateway.

7. The method as claimed in claim 3, wherein receiving the information comprises receiving information as to whether a system failure has occurred in respective VoIP gateways via network equipment other than the VoIP gateways.

8. The method as claimed in claim 1, further comprising generating a database to establish the routing path in accordance with the received information.

9. The method as claimed in claim 8, wherein the database comprises at least one of an IP address and a MAC address of the VoIP gateway.

10. The method as claimed in claim 8, wherein the database comprises information on a VoIP gateway where a failure has occurred and a VoIP gateway to bypass the VoIP gateway where a failure has occurred.

11. A method comprising:
determining whether a failure has occurred in each of more than one VoIP gateway and transmitting information as to whether a failure has occurred;
generating a database including information as to whether a failure has occurred in accordance with the information transmitted from the VoIP gateway, the database being generated by a management server; and
establishing a routing path by selecting a VoIP gateway where a failure has not occurred to bypass a VoIP gateway where a failure has occurred in accordance with the database, the routing path being established by the management server.

12. The method as claimed in claim 11, further comprising sending the information on a message between the VoIP gateway and the management server.

13. The method as claimed in claim 12, wherein the message comprises at least one of a field indicating a presence or absence of available ports, a field for a protocol ID, and a field for a VoIP gateway.

14. The method as claimed in claim 11, wherein the database comprises information on a VoIP gateway where a failure has occurred and a VoIP gateway to bypass the VoIP gateway where a failure has occurred.

15. A VoIP system, comprising:
VoIP gateways adapted to determine if a failure has occurred in VoIP gateways and to transmit information as to whether a failure has occurred; and
a management server adapted to receive information as to whether a failure has occurred and to generate a database including information as to whether a failure has occurred in the VoIP gateways in accordance with the received information transmitted from the VoIP gateways, and to establish a routing path by selecting a VoIP gateway where a failure has not occurred to bypass a VoIP gateway where a failure has occurred in accordance with the database.

16. The VoIP system as claimed in claim 15, wherein a failure of a VoIP gateway comprises at least one of a network failure and an exhaustion of available ports.

17. The VoIP system as claimed in claim 16, wherein the information is transmitted on a message between a VoIP gateway and the management server.

18. The VoIP system as claimed in claim 17, wherein the message comprises at least one of a field indicating a presence or absence of available ports, a field for a protocol ID, and a field for a VoIP gateway.

19. The VoIP system as claimed in claim 15, wherein the database comprises information on a VoIP gateway where a failure has occurred and a VoIP gateway to bypass the VoIP gateway where a failure has occurred.
